(19) United States
(12) Patent Application Publication
(10) Pub. No.: US 2009/0171978 A1
(43) Pub. Date: Jul. 2, 2009

(54) SERVER DEVICE AND INFORMATION TERMINAL FOR SHARING INFORMATION

(76) Inventors: Norihiko Naono, Tokyo (JP); Kunihiko Ohnaka, Tokyo (JP); Mitsutaka Okazaki, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/342,895

(22) Filed: Dec. 23, 2008

(30) Foreign Application Priority Data
Dec. 27, 2007 (JP) P2007-336507

(51) Int. Cl. G06F 17/30; H04L 9/00

(52) U.S. Cl. 707/10; 707/201; 713/150; 707/E17.032

(57) ABSTRACT

A technique for synchronization of the information on multiple information terminal devices is disclosed. The information to be stored is stored in encrypted format in a server unit, and thus the server unit administrator cannot access this information. In the information terminal device where information is to be synchronized, encrypted changed information, where difference information or any set of difference information generated due to changes in the information, is encrypted, and is sent to the server unit. Then the server unit stores this encrypted changed information by correlating a revision number with it. A terminal device receives the revision number correlated with the encrypted changed information, and stores it by correlating it with the difference information or any set of difference information. The information is synchronized by maintaining consistency between information terminal devices, whose information is to be synchronized, by executing “Commit” and “Update” while exchanging the revision number correlated with the encrypted changed information, between the server unit and each information terminal device.

### CROSS REFERENCE TO RELATED APPLICATION

This application is based upon and claims the benefit of priority from the prior Japanese Patent Application No. P2007-336507, filed on Dec. 27, 2007, the entire contents of which are incorporated herein by reference.

### BACKGROUND OF THE INVENTION

1. Field of the Invention

The present invention relates to a technique for realizing synchronization of information stored in a plurality of information terminal devices while maintaining the consistency of the plurality of information.

2. Description of the Related Art

In recent years, multiple information terminal devices such as personal computers, PDAs (Personal Digital Assistance), etc. can be connected to a network owing to the development of the Internet Communication Technology. The server unit connected to a network provides services to these information terminal devices. As a part of such services, the management of various information for these information terminal devices is provided. One such example is a calendar service that is known for sharing a schedule between multiple people. Another such example is a service that is known for sharing an address book owned by one person among multiple information terminal devices.

In this way, personal information such as schedule and address book mentioned above is included as information shared among multiple information terminal devices. At present, as described in the U.S. Pat. No. 6,665,837, information is disclosed and obtained by sending and receiving e-mails in order to exchange related information with another person or another information terminal device through the internet. However, there is a problem in that the process of managing the information obtained by sending and receiving e-mails is time-consuming and information among multiple information terminal devices cannot be synchronized.

Since various information is added, updated, or deleted at any time on every information terminal device under the conditions in which the information is shared among multiple information terminal devices connected to each other over a network, it is difficult to synchronize the information to be stored in all information terminal devices. Moreover, multiple information terminal devices sharing the information are not always connected to the network. This is because each information terminal is connected to the network at one moment, but may be disconnected at the next moment. In such a case, it is not easy to synchronize the information between all information terminal devices where information is to be shared while maintaining consistency of the information.

As a technology for resolving the problem mentioned above, a technology is disclosed, for example by the U.S. Pat. No. 7,080,104, in which disclosure and synchronization of information on a web server unit is realized.

In order to synchronize information among information terminal devices using a server unit such as a web server unit, a database is stored on the web server unit. Further, the information that should be synchronized among information terminal devices is stored in this main database. While the information in the database may be in the plain text format, the information is generally encrypted. The encryption is, however, done so that the encrypted information can be decrypted by the server unit or the owner of its database. Otherwise, its owner or the service provider may not be able to manage the information with the conventional techniques.

### SUMMARY OF THE INVENTION

As mentioned above, in the conventional techniques, when the owner of the information, which should be synchronized among information terminal devices, is not the owner or the operator of the server unit or its main database, then the information is stored in the database either in the plain text format or in the encrypted format so that it can be decrypted by the operator or owner of the database. As far as the inventors of the present invention are aware, any technique that fulfils the requirement of encrypting and storing the information so that it can be decrypted only by the owner of each information terminal device, is not known. The synchronization of information among all information terminal devices while maintaining consistency of the information stored in the storage devices of multiple information terminal devices, with the information stored in the main database under a condition where it can be decrypted only by the owner of respective information terminal devices, is necessary because it can not be implemented by using the known techniques in the conventional database field.

One embodiment of the present invention provides a server device comprising: a reception device for receiving encrypted change information which shows a change in information stored in a storage device of an information terminal device, the change being caused by a change operation on the stored information, the encrypted change information being encrypted so that the information terminal device can decrypt the encrypted change information, and; a storage device which stores the encrypted change information.

Another embodiment of the present invention provides an information terminal device comprising: a key storage device which stores a decryption key; a reception device which receives encrypted information which can be decrypted by the decryption key, and revision information which shows an order in which the encrypted information is received by a server device; a decryption device which decrypts the received encryption information, and; a storage device which correlates the decrypted information with the received revision information.

Still another embodiment of the present invention provides an information sharing system comprising a server and a plurality of information terminal devices, each of the plurality of information devices including: a storage device which stores information in plain format, an encryption device which encrypts change information which shows a change in information caused by a change operation on the stored information, the change information being encrypted so that the plurality of information terminal devices can decrypt the encrypted change information, a transmission device which transmits the encrypted change information to the server, a reception part which receives the encrypted change information transmitted from another information terminal device among the plurality of information terminal devices via the server device, a decryption device which decrypts the received encrypted change information, and an updating device which updates the stored information in plain format based on the decrypted encrypted change information; and the server device including: a reception device which receives encrypted change information transmitted from one of the plurality of information terminal devices, a storage device which stores the received encrypted change information, and a transmission device which transmits the encrypted change information to another of the plurality of information terminal devices other than the information terminal device which transmit the encrypted change information.

### BRIEF DESCRIPTION OF THE DRAWINGS

FIG. 1 shows an example of communication between the information terminal devices and the server unit in one embodiment of the present invention.

FIG. 2 show a block diagram of the information terminal devices and the server unit of one embodiment of the present invention.

FIG. 3 shows a sequence of processing for maintaining the consistency of information among the plurality of the information terminal devices of one embodiment of the present invention.

FIG. 4a-4c shows an example of information stored in the information terminal devices and the server unit of one embodiment of the present invention.

FIG. 5 shows a sequence of processing for maintaining the consistency of information among the plurality of the information terminal devices of one embodiment of the present invention.

FIG. 6a-6c shows an example of information stored in the information terminal devices and the server unit of one embodiment of the present invention.

FIG. 7 show a block diagram of the information terminal devices and the server unit of one embodiment of the present invention.

FIG. 8 shows a sequence of processing for maintaining the consistency of information among the plurality of the information terminal devices of one embodiment of the present invention.

FIG. 9a-9c shows an example of information stored in the information terminal devices and the server unit of one embodiment of the present invention.

### DETAILED DESCRIPTION OF THE INVENTION

The best modes for implementing the present invention are disclosed below. Since the scope of the present invention is defined clearly by the claims, the disclosure in the present description should not be interpreted to be restricted to the embodiment described below and the disclosure simply aims to illustrate the general principles of the present invention.

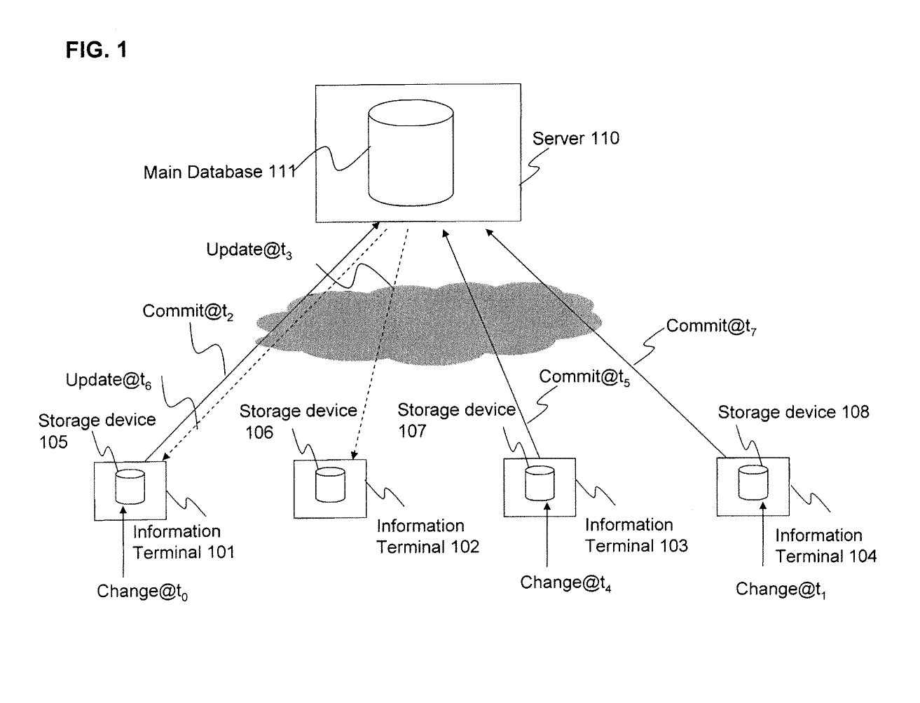

FIG. 1 shows an example of a configuration of a system where one embodiment of the present invention is implemented. This system includes a server unit 110 and multiple information terminal devices 101, 102, 103, and 104. For maintaining consistency and synchronizing information among the multiple information terminal devices, in principle, the server unit 110 is connected to a network and a main database 111 is comprised in the server unit 110. Each information terminal device sends update information to the server unit 110, which comprises the main database 111, and then the change information, which indicates the changes in the information stored in the main database 111 by executing a change operation, is sent from the server unit to each terminal device. Hereinafter, sending the change information from an information terminal device to the server unit is called a “Commit” operation and sending the change information from the server unit to the information terminal device is called an “Update” operation.

FIG. 1 shows an example where the information stored in the storage device of an information terminal device is changed. In the initial status, the information stored in the main database 111 of the server unit is the same as the information stored in the storage devices 105, 106, 107, and 108 of each information terminal device. Now, the information stored in the storage device 105 of information terminal device 101 is modified at time t₀. Then, the information stored in the storage device 106 of information terminal device 104 is modified at time t₁. After this, the change information of the information modified at time t₀ is committed at time t₂ for server unit 110 from the information terminal device 101, and among the information stored in the main database 111, the part corresponding to the information modified at time t₀ is updated. Then, among the information stored in the storage device of the server unit 110, the change information indicating the information modified at time t₀ is updated to information terminal device 102 at time t₃, and among the information stored in the storage device 106, the part corresponding to the information modified at time t₀ is updated. After this, the change in the information stored in the storage device 107 of the information terminal device 103 is added at time t₄. Then, a part or all the change information of the information stored in the storage device 107 is committed from information terminal device 103 to server unit 110 at time t₅, and among the information stored in the main database 111, the part corresponding to the information modified at time t₄ is updated. After this, among the information stored in the storage device of server unit 110, the change information of the information modified at time t₄ is updated to the information terminal device 101 at time t₆, and is stored in the storage device 105. Then, the change information of the information modified at time t₁ is committed from the information terminal device 104 to server unit 110 at time t₇, and among the information stored in the main database 111, the part corresponding to the information modified at time t₁ is updated.

As is shown in the example above, the server unit modified the information stored in the main database based on change information received at the time of the Commit operation from each information terminal device in which the synchronized information is to be stored. Moreover, the server unit updates the stored information for each information terminal device. In the technique disclosed below, the server unit 110 manages and compares the revision of information stored in the server unit 110 and each information terminal device, and synchronizes the information by maintaining consistency of information among the server unit 110 and each information terminal device.

Moreover, the database system in the server unit may be arranged with transaction management means, concurrent control means, failure recovery means and security protection means, which are generally used in a conventional database management system.

To synchronize the information stored in multiple information terminal devices along with maintaining the consistency of the information, the information may be stored in the main database located on the server unit as mentioned above in the form of plain text or in the form that can be decrypted by the administrator of the main database, and it is updated based on the change information sent when committed from each information terminal device. This is because the fields or the records that configure the main database cannot be modified when the information stored in the main database can not be decrypted or change information which cannot be decrypted is received by the server unit.

Communication with encryption can be, however, used for communication among multiple information terminal devices and the server unit. This is because there is a possibility of various attacks such as bugging, spoofing, man-in-the-middle attack etc. since each information terminal device and the server unit are connected to the network. In an example of the encryption on the communication route, in the case where information from the information terminal device 101 commits to the server unit 110, the information terminal device 101 and the server unit 110 have a common encryption and decryption key, the arithmetic and logic unit (ALU) of the information terminal device 101 encrypts the information to be committed by using this key and sends the information to the server unit 110. However, the arithmetic and logic unit (ALU) of the server unit 110 decrypts the information received from the information terminal device 101 by using this key and stores the information in the plain text format in the main database 111. In another example of the encryption on the communication route, the ALU of the information terminal device 101 encrypts the information to be committed by using the public key of the server unit 110 and sends the encrypted information to the server unit 110. Then the server unit 110 decrypts the information with its secret key and stores the information in the main database 111. Even in this case, the information stored in the main database in the form of the plain text or in a form that can be decrypted by the administrator of the main database is updated based on the committed change information.

In some cases, the information is updated at any time for the information terminal devices within the group of these information terminal devices by the group of information terminal devices other than shown in FIG. 1. For example, in the example shown in FIG. 1, the modification made in the information stored in the information terminal device 103 at time t₄ may be due to the information received through the network from an information terminal device other than information terminal devices 101, 102, 103 and 104. Not only the changes directly input by the operator of the information terminal device, but also the changes, which are to be made in the information by a group other than the group, to which the information terminal device belongs, where information should be synchronized through the network, are made arbitrarily at any time, then the synchronization becomes difficult while maintaining the consistency of the information in the group of information device terminals.

### Embodiment 1

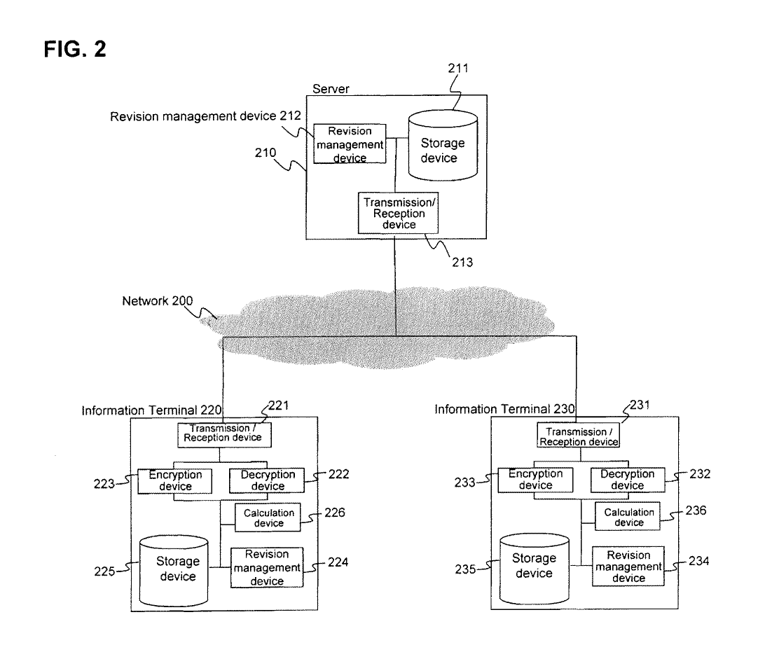

FIG. 2 shows an example of a server unit, information terminal devices and components of the system in which the present invention is applied to. However, the components that are not directly related to the present invention are not shown in FIG. 2. For example, input/output devices such as keyboards or displays are not shown even though these can be connected to the server unit or information terminal devices. The server unit 210 comprises a storage device 211, a revision management device 212, and a transmission/reception device 213. The information terminal device 220 comprises a transmission/reception device 221, a decryption device 222, an encryption device 223, a revision management device 224, a storage device 225, and a calculation device 226. Similarly, the information terminal device 230 comprises a transmission/reception device 231, a decryption device 232, an encryption device 233, a revision management device 234, a storage device 235, and a calculation device 236. In the example shown in FIG. 2, the server unit 210 is connected to the information terminal devices 220 and 230 through a network 200. The operations of these devices are described below.

FIG. 2 exemplifies a configuration in which the consistency of information is maintained and the information is synchronized among two information terminal devices. The number of information terminal devices is not limited to the number in this example. The key used for the encryption and the decryption is stored in the storage devices 225 and 235. This key may be a common key, which is shared among information terminal devices 220 and 230, or a pair of a public key and its secret key, the pair of which is shared among the information terminal devices 220 and 230. However, the storage device 211 of the server unit 210 does not necessarily store any key and does not necessarily include a means for entering either the shared key or the secret key.

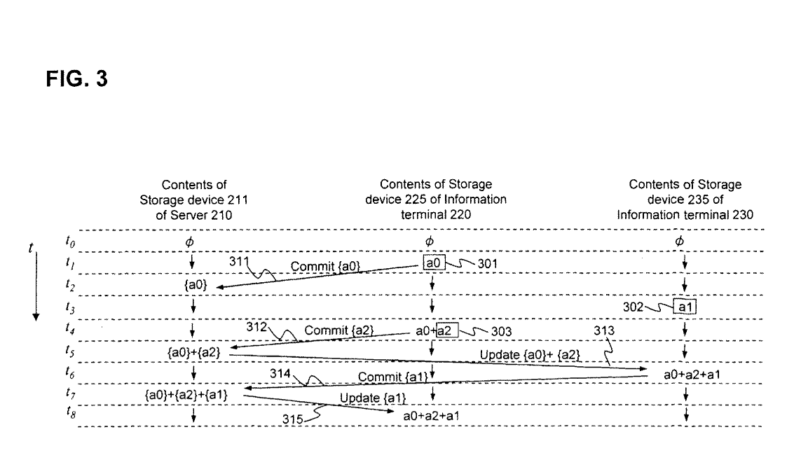

Referring to FIG. 3, a process to maintain the consistency of information among two information terminal devises is described in the present embodiment. FIG. 3 displays the contents of the storage device 211 of the server unit 210, the contents of the storage device 250 of the information terminal device 220, and the contents of the storage device 235 of the information terminal device 230. These contents changes along with the passage of the time as shown in FIG. 3. In FIG. 3, the time passes from top to bottom and tₙ indicates a time sequence. Here, the time indicated by t₀ must not signify a moment, but it may express a period of a certain length. Thus multiple events may occur during tₙ. Referring to FIG. 3, the information a₀ is input into the information terminal device 220 and at time t₁ the information a₀ (301) is stored in the storage device 225. Similarly, the information a₁ is entered into the information terminal device 230 and at time t₃, and information a₁ (302) is stored in the storage device 235. Moreover, the information a₂ is input into the information terminal device 220, and at time t₄ the information a₂ (303) is stored in the storage device 225.

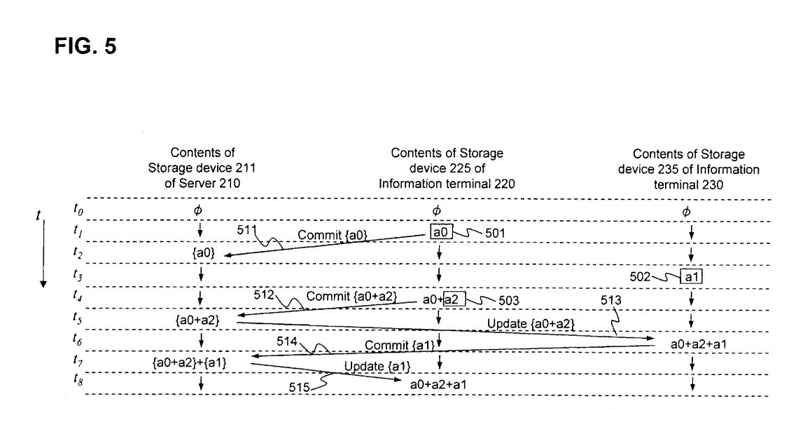

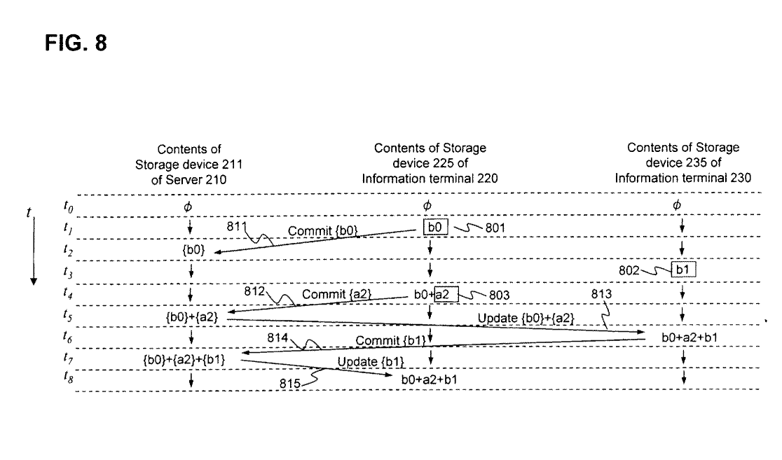

In FIG. 3, the information a₀ (301), a₁ (302), and a₂ (303) in the squares indicate the information is becomes the state of being stored in the storage device of each information terminal device at the time. Also in FIG. 3, {a₀}, {a₁}, {a₂}, etc. brackets indicate that a₀, a₁, and a₂ are encrypted respectively. And a₀, a₁, and a₂, which are not enclosed in brackets, indicate that a₀, a₁, and a₂ are in the non-encrypted form, e.g. in the form of the plain text. Moreover, the notation {a0}+{a1} indicates that the information a₀ and the information a₁ are combined, concatenated, or correlated after being encrypted separately. The notation {a0+a1} indicates that the information a₀ and the information a₁ are encrypted as a whole after being combined, concatenated, or correlated. The encryption may be an encryption using a shared common key such as DES, the triple DES, AES, or a public key such as the RSA algorithms by Rivest, Shamir, and Adleman. The information a₀ (501), a₁ (502), a₂ (503), b₀ (801), b₁ (802), and a₂ (803) referred in FIGS. 5 and 8 are also interpreted in the same way.

In FIG. 3, a₀ (301), a₁ (302), and a₂ (303), which are enclosed in squares, are also the change information indicating the changes in information caused by modification operations and are added to the information stored in the storage devices. For example; when an address of Alice is newly added to an address book, then it is a piece of information that indicates the addition of name, address, etc. of Alice. Thus, the encrypted {a₀}, {a₁} and {a₂} are called encrypted change information. In FIG. 5, which is explained below, {a₀+a₂}, which is a result of encrypting a₀+a₂, is a piece of encrypted change information. Moreover, in FIG. 8, b₀ (801) and a₂ (803), each of which is enclosed in a square, are change information showing addition of b₀ (801) and a₂ (803) respectively is performed. Thus, {b0} and {a2} are encrypted change information. In the examples in FIG. 3, FIG. 5, and FIG. 8, there are two or less records of change information in the storage device of each information terminal device. However, when there are three or more records of changed information, it can be encrypted by combining any of the change information. Information that is encrypted in such a manner is encrypted change information.

FIG. 3, FIG. 5, and FIG. 8 exemplify the cases in which change information indicates an addition of information to the storage device. However change information can also show a deletion of information. In the system where additions and deletions are mixed, flag information for identifying the additions or deletions can be included in the change information. For example, when Bob's address is changed, then the change information includes the flag information to identify the additions of Bob's name and Bob's changed address. Further, when David's information is deleted, the change information includes the flag information to identify the deletions and the information that uniquely specifies David's information (For example, David's personal identification information). As shown in this example, when change information indicates the difference before and after changing the information, then the change information includes the information indicating those changes.

When a common key is to be used, the storage device 225 of the information terminal device 220 and the storage device 235 of the information terminal device 230 share the same common key. Information, sent to the server unit, is encrypted by the encryption devices 223 or 233 by using this common key, and then the transmission/reception device sends the information to the server unit 210. Further, when encrypted information is sent from the server unit to the information terminal device 220, the transmission/reception device 221 receives the information, then the information is decrypted by the decryption device 222 and then the information is stored in the storage device 225 in the plain text format.

While encrypting or decrypting the information using a public/secrete key scheme, it is necessary to use a pair of a public key and a secret key, which is shared by the information terminal devices 220 and 230. In other words, the secret key in this pair has been stored in the storage device 225 of the information terminal device 220 and the storage device 235 of the information terminal device 230. For example, the following steps are performed to send the information to the server unit 210 after the information is encrypted in information terminal device 220. First, the information terminal device 220 acquires a public key from another server unit or the information terminal device connected to the network, and then stores the key in the storage device 225. Or, it is also possible to generate a pair of public key and a secret key in the calculation device 226 of an information terminal device and store the keys in the storage device 225. Further, the encryption device 223 encrypts the information, which is to be sent to the server unit, by using the public key stored on the storage device 225, and then the transmission/reception device 221 sends the information to the server unit. When the encrypted information is sent from the server unit to information terminal device 220, the transmission/reception device 221 receives the information, and then the encrypted information is decrypted by decryption device 222 and stored in the storage device 225 in the plain text format.

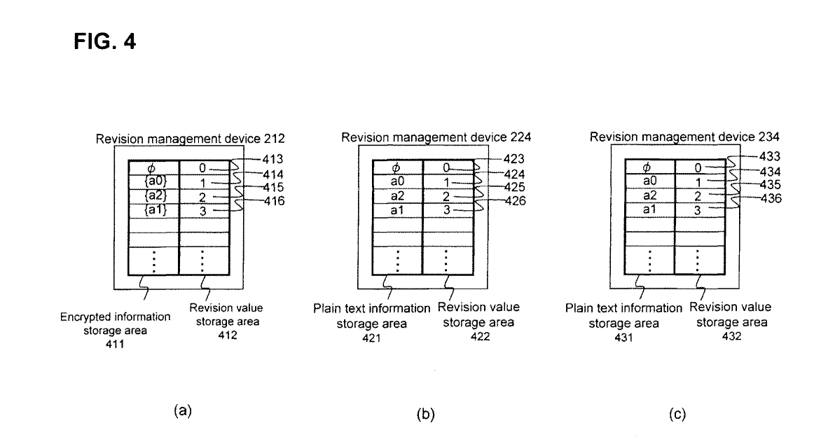

Referring to FIG. 2, FIG. 3, and FIG. 4, an example of the process of synchronizing information while maintaining the consistency of the information among server unit 210 and the information terminal devices 220 and 230 is explained. In this case, all the information is encrypted and stored in the storage device 211 of the server unit 210. The server unit 210 needs not to be able to decrypt this encrypted information. In the example shown in FIG. 3, the contents of the storage device 211 of the server unit 210, the storage device 225 of the information terminal device 220 and the storage device 235 of the information terminal device 230 are assumed to be indicated by the empty set φ in the initial state at time t₀. Here, the same information as the empty set φ is shared among the server unit 210 and the information terminal devices 220 and 230. Moreover, the revision number stored in the revision value storage area 412 of the revision management device of server unit 210 is assumed to be 0 (413). Similarly, the revision value storage area's revision number (423), which is stored in the revision management device 224 of the information terminal device 220, and the revision number (433), which is stored on the revision management device 234 of the information terminal device 230 are also assumed to be 0.

First, the information a₀ (301) is stored in the plain text format in the storage device 225 at t₁. Then, the information terminal device 220 encrypts the information a₀ and then commits the encrypted change information {a₀} to the server unit 210. In other words, a₀ is difference information of the information stored on the information terminal device 220 between before and after executing the operation at t₁.

Next, the encrypted change information {a₀} is stored in the storage device 211 of the server unit 210 at t₂. In this case, the revision management device 212 generates 1 as the next revision number and stores this encrypted change information {a₀} and the revision number 1 (414) by correlating them with each other. Moreover, the server unit 210 notifies the information terminal device 220 with the information that the revision number of received encrypted change information {a₀} is 1. The information terminal device 220, which receives this notification, stores 1 (424), which is the revision number received from the server unit by correlating with the plain text information a₀, in the revision value storage area 422 of the revision management device 224. At this point, the revision number stored in the server unit 210 and the information terminal device 220 becomes the same, and the information in the server unit 210 and the information in terminal device 220 is synchronized.

Further, the information a₁ (302) is stored in the storage device 235 in the plain text format at t₃. In the example shown in FIG. 3, the information terminal device 230 does not commit the information to the server unit 210 until t₆. At t₃, the information stored in the revision management device 234 of the information terminal device 230 is not changed and the revision number 0 is correlated with φ.

The information a₂ (303) is stored in the storage device 225 in the plain text format at t₄. Consequently, the information a₀ and a₂ are stored at this point of time in the storage device 225. The information terminal device 220 encrypts the information a₂, which has not been committed yet, and then commits (312) the information to the server unit 210.

Next, the encrypted changed information {a₂} is stored in the storage device 211 of the server unit 210 at t₅. In this case, the revision management device 212 stores this encrypted change information {a₂} by correlating with revision number 2 (415) obtained by incrementing the current revision number by 1 as the next revision number. Moreover, the server unit 210 notifies to the information terminal device 220 that the revision number of the received encrypted change information {a₂} is 2. The information terminal device 220, which receives this notification, stores information a₂ in the plain text format correlated with revision number 2 (425), which is received from the server unit, in the revision value storage area 422 of the revision management device 224. At this point, the revision number stored in the server unit 210 and the information terminal device 220 becomes the same, and the information in the server unit 210 and the information terminal device 220 is synchronized again.

Subsequently, the server unit 210 updates the information for information terminal device 230 (313). In this case, the server unit 210 inquires the current revision number for the information terminal device 230, and the information terminal device 230 returns the revision number 0 (433) stored at this point of time in its revision management device 234 to the server unit 210. Further, the revision management device of the server unit 210 refers to the latest revision number 2 (415) in the revision value storage area at that time and compares it with the revision number 0 that is received from the information terminal device 230. 2 and 0 are different, and since 2 is greater than 0, the information, which is stored in the storage device 211 of the server unit 210, but not stored in the storage device 235 of information terminal device 230 is detected based on this comparison result. In other words, this information i.e. the encrypted change information {a₀} and {a₂} are sent to the information terminal device 230 through the transmission/reception device 213 (313). At this time, the revision number 1 correlated by the revision management device 212 of the server unit 210 is correlated with the encrypted change information {a₀}, and the revision number 2 correlated by the revision management device 212 is correlated with the encrypted change information {a₂} and are sent to the information terminal device 230. Information terminal device 230 decrypts the encrypted change information {a₀} and {a₂} received from the server unit 210 by using the decryption device 232. After that, the information a₀ and a₂ is stored in the plain text format in the storage device 235. At this point, the information a₀ and a₂ are stored in the storage device 235 of the information terminal device 230 at t₆ in addition to a₁. Here, the revision number 1 correlated with the information a₀ in the plain text format, and the revision number 2 correlated with the information a₂ in the plain text format are stored respectively in the revision value storage area of revision management device 234. Further, the latest revision number stored in the revision management device 234 of the information terminal device 230 is incremented from 0 to 2 at t₆. In this way, the revision number can be incremented by more than 1 by executing the Commit operation or the Update operation once, or the Commit operation or the Update operation may be executed every time the revision number is incremented by 1.

Further, by using the encryption device 233, the information terminal device 230 encrypts the plain text information a₁, which is stored in the storage device 235 and has not been committed yet, and then commits it to the server unit 210 (314).

Further, the encrypted change information {a₁} is stored in the storage device 211 of the server unit 210 at t₇. In this case, the revision management device 212 stores this encrypted change information {a₁} and the revision number 3 (416), which is incremented by 1, by correlating them with each other. Moreover, the server unit 210 notifies to the information terminal device 230 that the revision number of the received encrypted change information {a₁} is 3. The information terminal device 230, which receives this information, stores 3 (436), which is the revision number received from the server unit by correlating with information a₁ in the plain text format, in the revision value storage area 432 of the revision management device 234. At this point, the revision number stored in the server unit 210 and the information terminal device 230 becomes the same, and the information in the server unit 210 and the information terminal device 230 is synchronized.

Subsequently, the server unit 210 updates the information to the information terminal device 220 (315). In this case, the server unit 210 inquires the current revision number to the information terminal device 220 and the information terminal device 220 returns the latest revision number, i.e. 2 (425) stored in its revision management device 224 to the server unit 210. Further, the revision management device of the server unit 210 refers to the revision number 3 in the revision value storage area 412 at that time and compares it with the revision number 2, which is received from the information terminal device 220. Based on this comparison result, the encrypted change information {a₁}, which is stored in the storage device 211 of the server unit 210, but not stored in the storage device 225 of the information terminal device 220 is sent to the information terminal device 220 through the transmission/reception device 213 (315). At this time, the revision number 3 correlated by the revision management device 212 of the server unit 210 is correlated with the encrypted change information {a₁} and is sent to the information terminal device 230. Information terminal device 220 decrypts the encrypted change information {a₁} received from the server unit 210 by using the decryption device 232. After that, the information a₁ in the plain text format is stored in the storage device 225. At this point, a₁ is stored in the storage device 225 of the information terminal device 220 in addition to a₀ and a₂. Here, the revision number 3 correlated with the plain text information a₁ is stored in the revision value storage area of the revision management device 224.

Thus, the storage device 225 of the information terminal device 220 and the storage device 235 of the information terminal device 230 are synchronized through the server unit 210.

FIG. 3 shows an example of a sequence of the Commit operation and the Update operation. Further, in FIG. 3, for simplicity, the contents of the information stored in respective storage devices of the server unit 210, the information terminal devices 220 and 230, are the same at t₀ at initial state, and it is described using a specific example where the revision number is 0 at t₀ in the initial status. However, in the method of the present invention, the information stored in the server unit and all information terminal devices need not be synchronized in the initial status, and any combination of information is possible in the initial status of the server unit and each information terminal device.

According to one embodiment of the present invention, even in the conditions where each information terminal device is connected to or disconnected from a network at any time, the synchronization can be maintained while maintaining consistency in the information stored in the storage device of a information terminal device through a server unit without decrypting the information stored in the server unit at the server unit.

### Embodiment 2

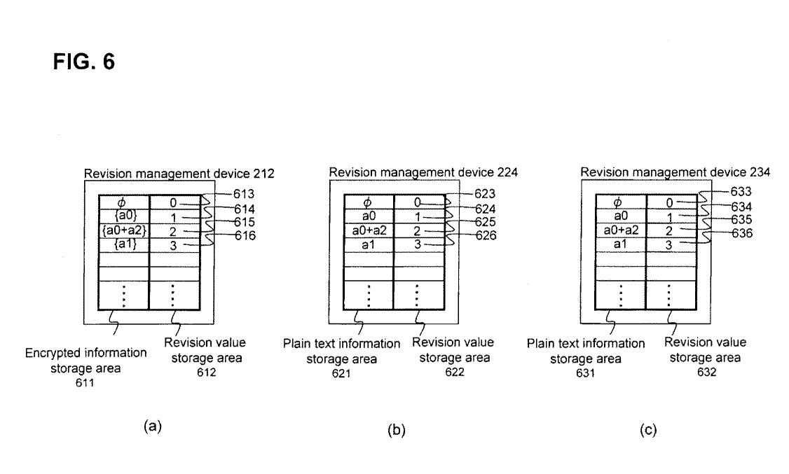

An example of another embodiment related to the present invention is explained with reference to FIG. 5 and FIG. 6. Further, in the present embodiment, a large part of the steps for synchronizing the information between information terminal devices is the same as the corresponding steps in the embodiment 1 mentioned previously. In the present embodiment explained below, a description of those steps which are as same as those in the embodiment 1 mentioned previously is omitted.

In FIG. 5, the processes in the server unit 210, and information terminal devices 220 and 230 at t₀ to t₃ are exactly the same as those in the embodiment 1 mentioned above.

It is assumed here that the information a₂ is stored in the storage device 225 at t₄ (503). Consequently, the contents to be stored in the storage device 225 at this point of time are a₀ and a₂. Further, the encryption device 223 of the information terminal device 220 combines the information a₀ and a₂, then creates the encrypted change information {a₀+a₂} by encrypting all the information after it is combined, concatenated, or correlated. Then, this encrypted change information {a₀+a₂} is committed to the server unit 210 (512).

Further, the encrypted change information {a₀+a₂} is stored in the storage device 211 of the server unit 210 at t₅. In this case, the revision management device 212 stores this encrypted change information {a₀+a₂} and the revision number 2 (615) by correlating them with each other. Moreover, the server unit 210 notifies that the revision number of received encrypted change information {a₀+a₂} is 2, to the information terminal device 220. The information terminal device 220, which receives this information, stores 2 (625), which is the revision number received from the server unit by correlating with the plain text information a₀+a₂, in revision value storage area 622 of the revision management device 224. At this point, the revision number stored in the server unit 210 and information terminal device 220 becomes the same, and the information in the server unit 210 and information terminal device 220 is synchronized.

Subsequently, the server unit 210 updates the information to the information terminal device 230 (513). In this case, the server unit 210 inquires the current revision number to the information terminal device 230, and the information terminal device 230 returns the latest revision number i.e. 0 (633) stored in its revision management device 234 to the server unit 210. Further, the revision management device of the server unit 210 refers to the latest revision value 2 (615) in the revision value storage area 612 at that time and compares it with the revision number 0 that is received from the information terminal device 230. Based on this comparison result, the information, which is stored in the storage device 211 of the server unit 210, but not stored in the storage device 235 of the information terminal device 230, is detected. In other words, the encrypted changed information {a₀+a₂} is sent to the information terminal device 230 through the transmission/reception device 213 (513). At this time, the revision number 2 correlated by the revision management device 212 of the server unit 210 is correlated with the encrypted change information {a₀+a₂} and is sent to the information terminal device 230. The information terminal device 230 decrypts the encrypted change information {a₀+a₂} received from the server unit 210 by using the decryption device 232. After that, the information a₀+a₂ in the plain text format is split into a₀ and a₂, and a₀ and a₂ are stored in the storage device 235. Here, the revision number 2 associated with the plain text information a₀+a₂ is stored in the revision value storage area of the revision management device 234. At this point, the information in the storage device of the server unit 210 and the information terminal device 220 is synchronized.

Further, by using the encryption device 233, the information terminal device 230 encrypts the plain text information a₁ stored in the storage device 235, which has not been committed yet, and then commits it to the server unit 210 (314).

Further, the encrypted changed information {a₁} is stored in the storage device 211 of the server unit 210 at t₇. In this case, the revision management device 212 stores this encrypted change information {a₁} and the revision number 3 (616), which is incremented by 1 by correlating them with each other. At that point, the encrypted change information {a₀+a₂} and {a₁} are stored in the storage device 213 of the server unit. Moreover, the server unit 210 notifies that the revision number of the received encrypted change information {a₁} is 3, to the information terminal device 230. The information terminal device 230, which receives this information, stores 3 (636), which is the revision number received from the server unit by correlating with the plain text information a₁, in revision value storage area 632 of the revision management device 234. At this point, the revision number stored in the server unit 210 and the information terminal device 230 becomes the same, and the information in the server unit 210 and the information terminal device 230 is synchronized.

Subsequently, the server unit 210 updates the information to the information terminal device 220 (515). In this case, the server unit 210 inquires the current revision number to the information terminal device 220, and the information terminal device 220 returns the revision number i.e. 2 (625) stored in its revision management device 224 at that time to the server unit 210. Further, the revision management device of the server unit 210 refers to the value 3 (616) stored in the revision value storage area 612 at that time and compares it with the revision number 2, which is received from the information terminal device 220. Based on this comparison result, the information, which is stored in the storage device 211 of the server unit 210, but not stored in the storage device 225 of the information terminal device 220, is detected. The encrypted change information {a₁} is sent to the information terminal device 230 through the transmission/reception device 213 (515). At this time, the revision number 3 correlated by the revision management device 212 of the server unit 210 is correlated with the encrypted changed information {a₁} and is sent to the information terminal device 230. The information terminal device 220 decrypts the encrypted change information {a₁} received from the server unit 210 by using the decryption device 232. After that, the information a₁ in the plain text format is stored in the storage device 225. At this point, a₁ is stored in the storage device 225 of the information terminal device 220 in addition to the plain text information a₀ and a₂. Here, the revision number 3 (626) correlated with the plain text information a₁ is stored in the revision value storage area of the revision management device 224. Here, the synchronization of the information stored in the server unit and the information terminal device 220 is complete.

The difference between the embodiment 1 and the embodiment 2 as well as the merits of the embodiment 2 is described below. In the embodiment 1, all the information i.e. a0, a1, and a₂ are encrypted individually by the information terminal and are sent to the server unit 210 as the encrypted change information {a₀}, {a₁}, {a₂}. In the server unit, the consistency of information between the information terminals is maintained by associating a revision number to each encrypted information. When the information terminal device commits the encrypted change information in the embodiment 2, there are cases where the information which is different from the embodiment 1 is sent. In other words, by the Commit operation, all or a part of change information in the plain text format stored in the information terminal device is encrypted after it is combined, concatenated, or correlated, and then the encrypted change information is sent to the server unit.

The following problems may occur in the embodiment 1. If several modification operations such as the addition, the update, deletion, etc. of information to and from each information terminal device are continued one after another, then the number of encrypted change information to be stored in the storage device of the server unit increases. Consequently, the size of the table required for revision management, which is managed by the revision management device, also increases. Further, when the time interval of adding, updating, deleting etc. the information to and from each information terminal device is less than the time interval of the Commit operation or the Update operation, then the large amount of small encrypted change information must be sent and received through the network and thus transmission efficiency declines. On the other hand, in the embodiment 2, since the plain text information stored in the information terminal device can be collectively sent to the server unit as a single encrypted change information, and the information can be sent from the server unit to an information terminal device, it is possible to control the number of encrypted change information stored in the server unit and the increase in the table size of revision management table. It is also possible to increase the efficiency of the transmission/reception of the encrypted change information through the network.

In the embodiment 2, a person skilled in the art can provide several methods for combining, concatenating, or correlating and collectively encrypting the difference information of each information terminal device, and a method for sending this encrypted change information to the server unit. Consequently, the embodiment 2 may have an advantage wherein a highly efficient method can be adopted to achieve synchronization between the information terminal devices.

### Embodiment 3

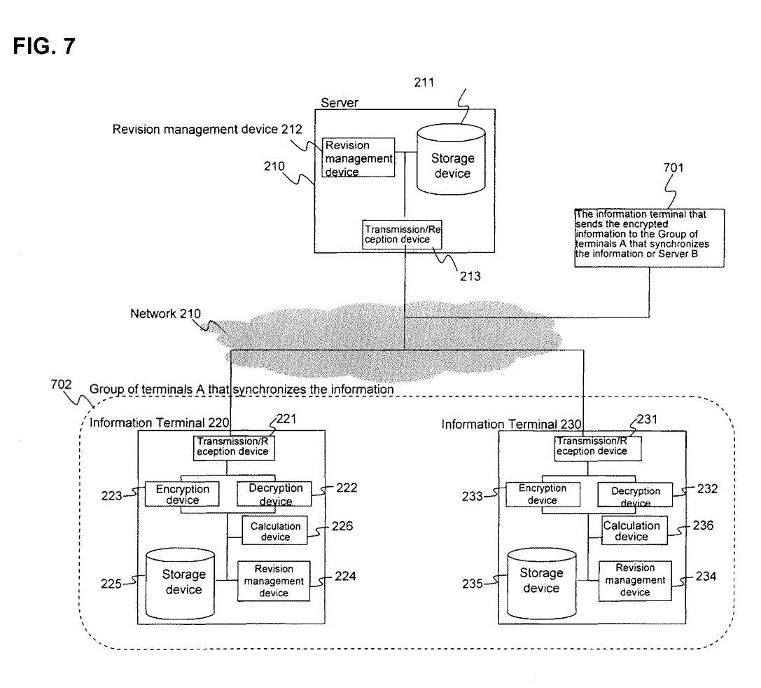

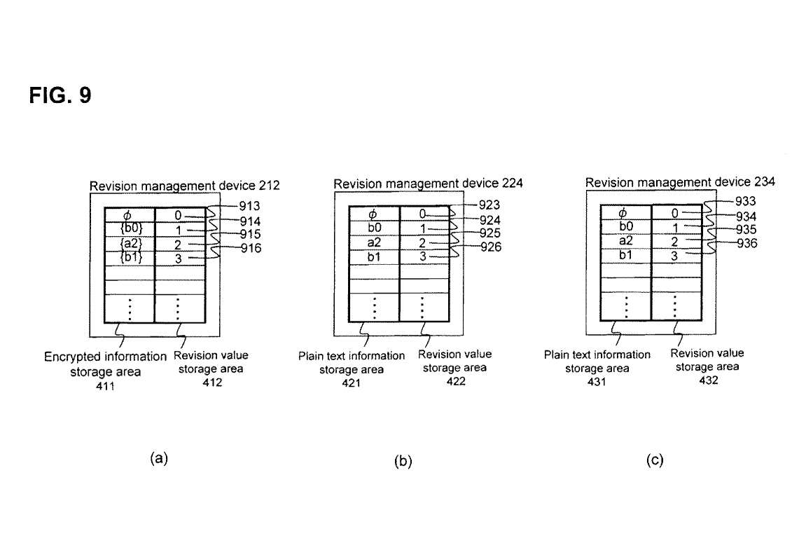

In the embodiments 1 and 2 stated above, methods are described to synchronize the information stored in two storage devices 225 and 235 of information terminal devices 220 and 230 respectively when updating this information. Below an outline is given of the embodiment 3 with reference to FIG. 7, FIG. 8, and FIG. 9. Here, the information terminals 220 and 230 are assumed to belong to a group A 702 of terminal devices, among of which information is synchronized. Further in the embodiment 3, for the group A of terminal devices, among which information is to be synchronized, the information terminal device or the server unit B 701, which sends the encrypted information that can be decrypted by each terminal device of the group A of terminal devices mentioned above, is available. This information terminal device or the server unit B 701 sends the information encrypted by using a public key of the group A of terminal devices to the information terminal device in the group A of terminal devices. Further, the information terminal device or the server unit B 701 can also send the information encrypted by using a public key of the group A of terminal devices to server unit 210.

Referring to FIG. 8, in the embodiment 3, the information terminal device 220 receives the encrypted information {b₀} sent by the information terminal device or the server unit B 701 at t₁. This information is decrypted by the decryption device 222 and is stored in the storage device 225 in the plain text b₀ (801). At this point, the plain text information b₀ is considered as the difference information in storage device 225 of an information terminal device. Further, b₀ is encrypted by the encryption device 223, and this encrypted difference information {b₀} is committed to server unit 210 (811).

Further, the encrypted changed information {b₀} is stored in the storage device 211 of the server unit 210 at t₂. The revision management device 212 stores this encrypted change information {b₀} by correlating it with revision number 1 (914). The server unit 210 notifies that the revision number of the received encrypted change information {b₀} is 1 to the information terminal device 220. The information terminal device 220, which has received this information, stores the revision number 1 (924) received from the server unit by correlating it with the plain text information b₀, in revision value storage area 422 of the revision management device 224. At this point, the revision number stored in the information terminal device 220 and the server unit 210 becomes the same, and the information in the information terminal device 220 and the server unit 210 is synchronized.

Further, the encrypted information {b₁} is sent from the information terminal device or the server unit B 701 to the information terminal device 230. The encrypted information is then decrypted by the decryption device 232 and is stored in the plain text format in the storage device 235 at t₃ (802). As shown in the example in FIG. 8, the information terminal device 230 does not commit the information to the server unit 210 until t₆. At t₃, the revision management device 234 of the information terminal device 230 is in the state where revision number 0 is correlated to φ, without any change.

At t₄, the information a₂, which may be directly input to the information terminal device 230, is stored in the plain text format in the storage device 225 (303). At that time, the contents of storage device 225 are b₀ and a₂. Further, the information terminal device 220 encrypts the information a₂, which is not yet committed, and then commits the encrypted change information {a₂} to the server unit 210 (812).

Further, the encrypted changed information {a₂} is stored in the storage device 211 of the server unit 210 at t₅. In this case, the revision management device 212 stores this encrypted change information {a₂} and the revision number 2 (915) obtained by incrementing the latest revision number by 1, by correlating them with each other. Moreover, the server unit 210 notifies that the revision number of the received encrypted change information {a₂} is 2, to the information terminal device 220. The information terminal device 220, which receives this information, stores 2 (925), which is the revision number received from the server unit by correlating with the plain text information a₂, in the revision value storage area 422 of the revision management device 224. At this point, the revision number stored in the server unit 210 and the information terminal device 220 becomes the same, and the information in the server unit 210 and the information terminal device 220 is synchronized again.

Subsequently, the server unit 210 updates the information to information terminal device 230 (813). In this case, the server unit 210 inquires the current revision number to the information terminal device 230, and the information terminal device 230 returns the latest revision number i.e. 0 (933) stored in its revision management device 234 to the server unit 210. Further, the revision management device of the server unit 210 refers to the latest revision value 2 (915) stored in the revision value storage area 412 at that time and compares it with the revision number 0 that is received from the information terminal device 230. Based on this comparison result, the information, which is stored in the storage device 211 of the server unit 210, but not stored in the storage device 235 of the information terminal device 230, is detected. This information i.e. the encrypted change information {b₀} and {a₂} are sent to the information terminal device 230 through the transmission/reception device 213 (813). At this time, the revision number 1 correlated by the revision management device 212 of the server unit 210 is correlated with the encrypted changed information {b₀}, and the revision number 2 correlated by the revision management device 212 is correlated with the encrypted information {a₂}, and are sent to the information terminal device 230. Information terminal device 230 decrypts the encrypted change information {b₀} and {a₂} received from the server unit 210 by using the decryption device 232. After that, the information b₀ and a₂ in the plain text format are stored in the storage device 235. At this point, b₀ and a₂ are stored in the plain text format at t₆ in storage device 235 of the information terminal device 230 in addition to b₁. Here, the revision number 1 correlated with the plain text information b₀ and revision number 2 correlated with the plain text information a₂ are stored respectively in the revision value storage area of the revision management device 234. At t₆, the revision number stored in the revision management device 234 of the information terminal device 230 is incremented from 0 to 2. In this way, the revision number can be incremented several times by the Commit operation or the Update operation, or it is also possible to execute the Commit operation or the Update operation each time while incrementing the revision number by 1.

Further, by using encryption device 233, the information terminal device 230 encrypts the plain text information b1 stored in the storage device 235, which has not been committed yet, and then commits the plain text information b1 to the server unit 210 as encrypted changed information {b1} (814).

Further, the encrypted changed information {b₁} is stored in the storage device 211 of the server unit 210 at t₇. In this case, the revision management device 212 stores this encrypted change information {b₁} and the revision number 3 (916), which is incremented by 1, by correlating them with each other. Moreover, the server unit 210 notifies that the revision number of received encrypted change information {b₁} is 3, to the information terminal device 230. The information terminal device 230, which receives this information, stores 3 (936), which is the revision number received from the server unit by correlating with the plain text information b₁, in revision value storage area 432 of the revision management device 234. At this point, the revision number stored in the server unit 210 and the information terminal device 230 becomes the same, and the information in the server unit 210 and the information terminal device 230 is synchronized.

Subsequently, the server unit 210 updates the information to the information terminal device 220 (815). In this case, the server unit 210 inquires the current revision number to the information terminal device 220, and the information terminal device 220 returns the latest revision number i.e. 2 (925) stored in its revision management device 224 to the server unit 210. Further, the revision management device of the server unit 210 refers to the revision number 3 stored in the revision value storage area 412 at that time and compares it with the revision number 2 that is received from the information terminal device 220. Based on this comparison result, the information, which is stored in the storage device 211 of the server unit 210 but not stored in the storage device 225 of information terminal device 220, is detected. This information i.e. the encrypted change information {b₁} is sent to the information terminal device 230 through the transmission/reception device 213 (815). At this time, the revision number 3 associated by the revision management device 212 of the server unit 210 is correlated with the encrypted changed information {b₁} and is sent to the information terminal device 230. The information terminal device 220 decrypts the encrypted change information {b₁} received from the server unit 210 by using the decryption device 232. After that, the information b₁ in the plain text format is stored in the storage device 225. At this point, b₁ is stored in the storage device 225 of the information terminal device 220 in addition to the plain text information b₀ and a₂, which are stored previously. Here, the revision number 3 correlated with the plain text information b₁ is stored in the revision value storage area of the revision management device 224.

Thus, the information in the storage device 225 of the information terminal device 220 and the storage device 235 of the information terminal device 230 is synchronized including the plain text information a₂, which may have been directly input to the information terminal device 220 and stored in its storage device, and the encrypted information {b₀} and {b₁} sent to the group A 702 of terminal devices that synchronizes the information received from the information terminal device or the server unit B 701.

In the embodiment 3, when the information, which may be directly input by the user to the information terminal device 220 or 230, and the encrypted information sent by a terminal device or the server unit to the information terminal device 220 or 230 that synchronizes the information, is stored in the storage device of the information terminal 220 or 230, then the information stored in the storage device of the information terminal devices 220 and 230 can be synchronized by maintaining consistency. At that time, the decryption of the information stored in the information terminal device can be prevented from being done in the server unit 210 as in the embodiment 1 and the embodiment 2.

In the embodiment 3, as shown in FIG. 7, it is possible to have multiple information terminal devices and the server units B 701 that send the encrypted information to the group A of terminal devices, which synchronizes the information. Further, there can be multiple information terminal devices that send the encrypted information to the group A of terminal devices, which synchronizes the information, and these information terminals can be a group of terminal devices which synchronizes the information by using the methods of the present invention.

Further, even in the case of embodiment 3, as explained in the embodiment 2, the method can be used whereby any difference information is encrypted after it is combined, concatenated, or correlated and it is committed as the encrypted changed information.

In the embodiment 3, for example, in a groupware, multiple terminal devices owned by person A is the group A 702 of terminal devices, which synchronizes the information as shown in FIG. 7, and person B discloses information to this group A 702 of terminal devices. By using the methods in this embodiment 3, the information disclosed by the terminal device owned by person B, as well as the information that is input by person A himself to its terminal devices, can be synchronized between multiple terminal devices owned by person A.

As described above, the present invention enables the synchronization of information stored in each information terminal device while maintaining the consistency of the information stored in a storage device of each of multiple information terminal devices, with the information stored in the main database in a state where such information can be decrypted only by the owner of the respective information terminal device.

What is claimed is:

1. A server device comprising:
a reception device for receiving encrypted change information which shows a change in information stored in a storage device of an information terminal device, the change being caused by a change operation on the stored information, the encrypted change information being encrypted so that the information terminal device can decrypt the encrypted change information; and
a storage device which stores the encrypted change information.

2. The server device according to claim 1, wherein the change information is difference information between information stored in a storage device of the information terminal device before the change operation and information stored in a storage device of the information terminal device after the change operation.

3. The server device according to claim 1, wherein the change information is stored in a storage device of the information terminal device after the change operation.

4. The server device according to claim 1, wherein the storage device correlates the encrypted change information with a revision information, the revision information showing an order in which the encrypted change information is received via the reception device.

5. The server device according to claim 4, further comprising a transmission device which transmits the revision information to the information terminal device.

6. The server device according to claim 5, further comprising:
a second reception device for receiving the transmitted revision information which is stored as terminal revision information by an information terminal device;
an calculation device which compares the received terminal revision information with the transmitted revision information, and;
a second transmission device which transmits to the information terminal device the encrypted change information which is correlated with the revision information in the case where an order which shows the terminal revision information is before an order which shows the revision information.

7. The server device according to claim 4, further comprising a transmission device in which the encrypted change information and the revision information which is correlated with the encrypted change are transmitted.

8. The server device according to claim 7, further comprising:
a second reception device for receiving the transmitted revision information which is stored as terminal revision information by an information terminal device;
an calculation device which compares the received terminal revision information with the transmitted revision information, and;
a second transmission device which transmits to the information terminal device the encrypted change information which is correlated with the revision information in the case where an order which shows the terminal revision information is before an order which shows the revision information.

9. The server device according to claim 1, wherein the reception device can receive encrypted change information from a plurality of information terminal devices.

10. The server device according to claim 9, wherein the encrypted change information received by the reception device can be decrypted by a common key which is shared by the plurality of information terminal devices.

11. The server device according to claim 9, wherein the encrypted change information which the reception device receives from the plurality of information terminal devices, is encrypted by a pair of a secret key and a public key shared by the plurality of information terminal devices.

12. The server device according to claim 9, wherein the storage device correlates and stores revision information which shows an order of the encrypted change information received by the reception device from one of the plurality of information terminal devices, with the encrypted change information.

13. The server device according to claim 12, further comprising a transmission device which transmits specific revision information among a plurality of the revision information to an information terminal device which is the source of a transmission of the encrypted change information correlated with the specific revision information.

14. The server device according to claim 12, wherein specific revision information among a plurality of the revision information and the encrypted change information which is correlated with the specific revision information are transmitted to an information terminal device which is the transmission source of the encrypted change information.

15. The server device according to claim 10, wherein the common key is excluded from the storage.

16. The server device according to claim 10, wherein the public key is excluded from the storage.

17. An information terminal device comprising:
a key storage device which stores a decryption key;
a reception device which receives encrypted information which can be decrypted by the decryption key, and revision information which shows an order in which the encrypted information is received by a server device;
a decryption device which decrypts the received encryption information, and;
a storage device which correlates the decrypted information with the received revision information.

18. The information terminal device according to claim 17, further comprising:
an encryption device which encrypts change information, the change being caused by a change operation on the information stored in the storage device, the encrypted change information being unable to be decrypted by the server device, and;
a transmission device which transmits the encrypted change information.

19. The information terminal device according to claim 17, wherein the change information is difference information between information stored before the change operation and information stored after the change operation.

20. The information terminal device according to claim 17, wherein the change information is information stored after the change operation.

21. The information terminal device according to claim 17, wherein the key storage device stores a common key shared with another information terminal device, the encrypted change information which is received by the reception device is also received by the another information terminal device, and the decryption device decrypts the received encrypted information using the common key.

22. The information terminal device according to claim 17, wherein the key storage device stores a secret key shared with another information terminal device, the reception device receives encrypted information which is also received by the another information terminal device, and the decryption device decrypts the received encryption information using the secret key.

23. The information terminal device according to claim 18, wherein the key storage device stores a common key shared with another information terminal device, and the encryption device performs encryption using the shared common key.

24. The information terminal device according to claim 18, wherein the key storage device stores a secret key shared with another information terminal device, and the encryption device performs encryption using the secret key and a public key, the secret key and the public key being a pair.

25. The information terminal device according to claim 17, wherein the key storage device stores a secret key shared with another information terminal device, and the reception device receives encrypted information encrypted by the another information terminal device using a public key, the public key and the secrete key being a pair, the secret key being unshared by the another information terminal.

26. An information sharing system comprising a server and a plurality of information terminal devices,
each of the plurality of information devices including: a storage device which stores information in plain format, an encryption device which encrypts change information which shows a change in information caused by a change operation on the stored information, the change information being encrypted so that the plurality of information terminal devices can decrypt the encrypted change information, a transmission device which transmits the encrypted change information to the server, a reception part which receives the encrypted change information transmitted from another information terminal device among the plurality of information terminal devices via the server device, a decryption device which decrypts the received encrypted change information, and an updating device which updates the stored information in plain format based on the decrypted encrypted change information; and
the server device including: a reception device which receives encrypted change information transmitted from one of the plurality of information terminal devices, a storage device which stores the received encrypted change information, and a transmission device which transmits the encrypted change information to another of the plurality of information terminal devices other than the information terminal device which transmit the encrypted change information.

27. An information sharing method using a server and a plurality of information terminal devices, each of the plurality of information terminal devices storing information in the plain format, the information sharing method comprising:
generating and transmitting by one of the plurality of information terminal devices change information which shows a change information caused by a change operation on stored information, the change information being encrypted so that each of the plurality of information terminal devices can decrypt the encrypted change information;
receiving by another of the plurality of information terminal devices the encrypted change information transmitted by the information terminal device among the plurality of information terminal devices via the server;
decrypting the received encrypted change information;
updating by the another of the plurality of information terminal devices the stored information based on the decrypted encrypted change information;
receiving the encrypted change information by the server;
storing by the server the received encrypted change information, and;
transmitting by the server the encrypted change information to the another information terminal device among the plurality of information terminal devices.
